(19) United States
(12) Patent Application Publication
(10) Pub. No.: US 2003/0183706 A1
(43) Pub. Date: Oct. 2, 2003

(54) Cone crusher having eccentric inner bushing

(76) Inventor: Ming Yih Cheng, Chong Ho City (TW)

Correspondence Address: Ming Yih Cheng, P.O. Box 10-69, Chong Ho, Taipei, 235, TW

(21) Appl. No.: 10/105,304

(22) Filed: Mar. 26, 2002

(51) Int. Cl. B02B 1/00

(52) U.S. Cl. 241/46.06; 241/46.15

(57) ABSTRACT

A cone crusher includes a main frame having a chamber for rotatably receiving a eccentric housing, the housing includes an eccentric bore and a peripheral wall having different thicknesses for increasing the stone crushing effect. A inner bushing is received in the eccentric bore of the housing and includes an eccentric orifice for receiving stones to be crushed and a peripheral wall having different thicknesses for increasing the stone crushing effect. The inner bushing may be rotated relative to the housing, and a key may selectively securing the inner bushing to the housing.

### BACKGROUND OF THE INVENTION

1. Field of the Invention

The present invention relates to a stone breaker or a cone crusher, and more particularly to a cone crusher having an eccentric inner bushing.

2. Description of the Prior Art

Typical stone breakers or cone crushers comprise one or more hammers pivotally secured in a eccentric for breaking or crushing stones. The hammers will be easily damaged and should be replaced with the other new ones quickly, such that the cost for breaking or crushing stones is greatly increased.

The present invention has arisen to mitigate and/or obviate the afore-described disadvantages of the conventional cone crushers.

### SUMMARY OF THE INVENTION

The primary objective of the present invention is to provide a cone crusher including an eccentric inner bushing for increasing the stone crushing effect.

The other objective of the present invention is to provide a cone crusher including an eccentric inner bushing that may be adjusted relative to the supporting eccentric body thereof for adjusting the stone crushing effect.

In accordance with one aspect of the invention, there is provided a cone crusher comprising a main frame including a chamber formed therein, a eccentric body rotatably received in the chamber of the main frame, the eccentric body including an eccentric bore formed therein, and including a peripheral wall having different thicknesses for increasing the stone crushing effect, an inner bushing received in the eccentric bore of the eccentric body, and including an eccentric orifice formed therein for receiving stones to be crushed, and including a peripheral wall having different thicknesses for increasing the stone crushing effect, and means for securing the inner bushing to the eccentric body.

The eccentric body includes a recess formed therein, the inner bushing includes a plurality of depressions formed therein for selectively aligning with the recess of the eccentric body, and the securing means includes a key engaged in the recess of the eccentric body and either of the depressions of the inner bushing, for allowing the inner bushing to be adjusted relative to the supporting eccentric body and for adjusting the stone crushing effect.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a partial cross sectional view showing a cone crusher in accordance with the present invention;

FIG. 2 is a partial top plan schematic view illustrating an eccentric body and an eccentric inner bushing of the cone crusher;

FIG. 3 is a cross sectional view taken along lines 3-3 of FIG. 2; and

FIG. 4 is a cross sectional view similar to FIG. 3, illustrating the operation of the cone crusher.

### DETAILED DESCRIPTION OF THE PREFERRED EMBODIMENT

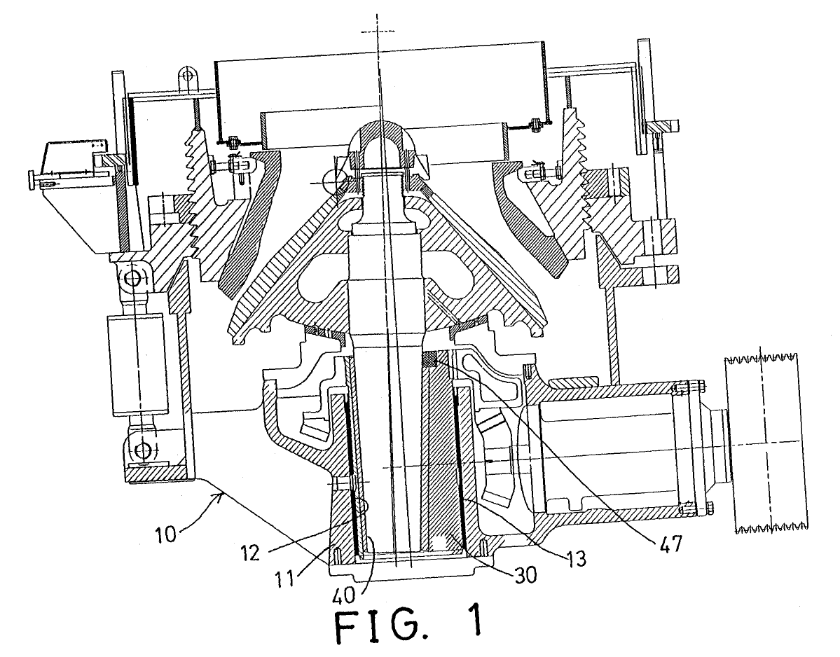

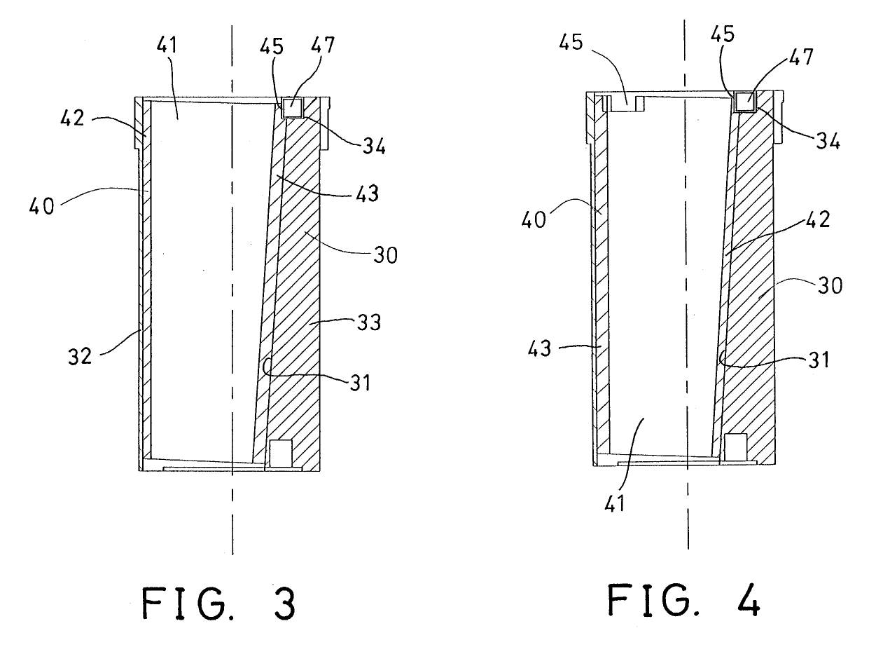

Referring to the drawings, and initially to FIGS. 1-3, a cone crusher 10 in accordance with the present invention comprises a main frame 11 provided therein, such as provided in the bottom portion thereof. The main frame 11 includes a chamber 12 formed therein for rotatably receiving a housing or an eccentric body 30. One or more gaskets or bearings or main frame bushings 13 may be disposed between the main frame 11 and the eccentric body 30 for facilitating the rotational movement of the eccentric body 30 in the main frame 11. The eccentric body 30 may be rotated or driven by various kinds of driving motors or rotating mechanisms for stone crushing purposes.

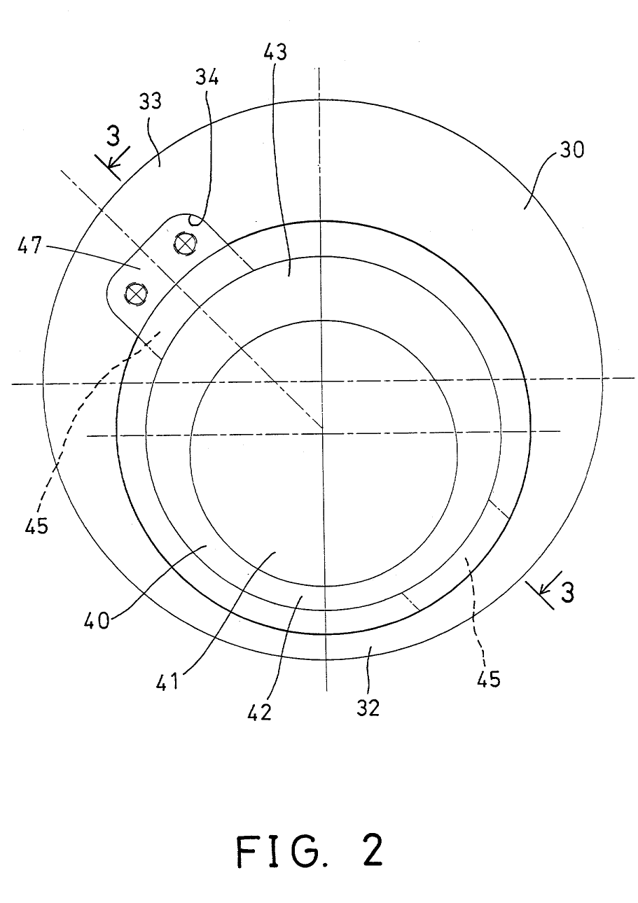

As best shown in FIGS. 2-4, the eccentric body 30 includes an offset or an eccentric bore 31 formed therein, for forming different wall thicknesses for the peripheral wall 32, 33 of the eccentric body 30. For example, the peripheral wall 32, 33 of the eccentric body 30 includes a thickness gradually increased from the thinner portion 32 toward the thicker portion 33. The eccentric body 30 includes a recess 34 formed in the upper portion of the peripheral wall 32, 33.

A barrel or an inner bushing 40 includes an outer peripheral portion shaped corresponding to that of the eccentric bore 31 of the eccentric body 30, for allowing the inner bushing 40 to be engaged into the bore 31 of the eccentric body 30. The inner bushing 40 may also include an offset or an eccentric orifice 41 formed therein, for forming different wall thicknesses for the peripheral wall 42, 43 of the inner bushing 40. For example, the peripheral wall 42, 43 of the inner bushing 40 includes a thickness gradually increased from the thinner portion 42 toward the thicker portion 43. The inner bushing 40 includes one or more depressions 45 formed in the upper portion of the peripheral wall 43, 43, for aligning with the recess 34 of the eccentric body 30.

A stop or a key 47 may be engaged in the recess 34 of the eccentric body 30 and either of the depressions 45 of the inner bushing 40 for securing the inner bushing 40 to the eccentric body 30 and for allowing the inner bushing 40 and the eccentric body 30 to be rotated in concert with each other.

In operation, as shown in FIGS. 1-3, the stones to be broken or crushed will be filled into the eccentric body orifice 41 of the inner bushing 40, and will be crushed by the inner bushing 40 when the inner bushing 40 and the eccentric body 30 are rotated relative to the main frame 11. The stones may be crushed by the inner bushing 40 due to the eccentric orifice 41 of the inner bushing 40, and/or due to the eccentric bore 31 of the eccentric body 30.

Referring next to FIG. 4, the inner bushing 40 may be rotated or adjusted relative to the eccentric body 30 when the key 47 is disengaged from the recess 34 of the eccentric body 30 and the depressions 45 of the inner bushing 40. The key 47 may be engaged into the recess 34 of the eccentric body 30 and the other depressions 45 of the inner bushing 40 again for securing the inner bushing 40 to the eccentric body 30 again. The inner bushing 40 may thus be rotated or adjusted relative to the eccentric body 30, and the thickness of the inner bushing 40 may thus be adjusted relative to the eccentric body 30 in order to adjust the stone crushing effects.

Accordingly, the cone crusher in accordance with the present invention includes an eccentric inner bushing for increasing the stone crushing effect, in which the inner bushing may be adjusted relative to the supporting eccentric body thereof for adjusting the stone crushing effect.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A cone crusher comprising:
a main frame including a chamber formed therein,
a eccentric body rotatably received in said chamber of said main frame, said eccentric body including an eccentric bore formed therein, and including a peripheral wall having different thicknesses,
an inner bushing received in said eccentric bore of said eccentric body, and including an eccentric orifice formed therein for receiving stones to be crushed, and including a peripheral wall having different thicknesses, and
means for securing said inner bushing to said eccentric body.

2. The cone crusher according to claim 1, wherein said eccentric body includes a recess formed therein, said inner bushing includes at least one depression formed therein for aligning with said recess of said eccentric body, and said securing means includes a key engaged in said recess of said eccentric body and said at least one depression of said inner bushing for securing said inner bushing to said eccentric body.

3. The cone crusher according to claim 1, wherein said eccentric body includes a recess formed therein, said inner bushing includes a plurality of depressions formed therein for selectively aligning with said recess of said eccentric body, and said securing means includes a key engaged in said recess of said eccentric body and either of said depressions of said inner bushing.
